(19) United States
(12) Patent Application Publication
(10) Pub. No.: US 2010/0300311 A1
(43) Pub. Date: Dec. 2, 2010

(54) Squeegee operating device for screen printing machine

(75) Inventor: Chin Jen Ku, Miaoli (TW)

Correspondence Address: CHARLES E. BAXLEY, ESQUIRE, 90 JOHN STREET, SUITE 309, NEW YORK, NY, 10038, US

(73) Assignee: Dadung Electromagnetic Co., Ltd.

(21) Appl. No.: 12/455,202

(22) Filed: May 30, 2009

(51) Int. Cl. B41L 13/18

(52) U.S. Cl. 101/123

(57) ABSTRACT

A screen printing machine includes a platen for supporting a substrate to be printed, a printing screen disposed above the platen, a squeegee to be moved across the printing screen in order to force an ink through the printing screen and onto the substrate, a conveyer device disposed below the platen, and a squeegee actuating device supported on the conveyer device, the squeegee actuating device includes a housing having a chamber for receiving one or more electromagnetic devices each of which include a coil having a compartment for receiving a core, and a magnet disposed above the core and secured to the core and the housing for being actuated by the core to selectively attract the squeegee to press onto the printing screen and to selectively release the squeegee.

### BACKGROUND OF THE INVENTION

1. Field of the Invention

The present invention relates to a screen printing machine, and more particularly to a screen printing machine including a squeegee actuating or operating device for easily actuating or operating a squeegee to apply a pressure onto a printing screen and to force the ink through the printing screen and onto the substrate.

2. Description of the Prior Art

Typical screen printing machines comprise a platen for supporting a garment or other substrate to be printed, a printing screen disposed or supported above the platen and the garment or other substrate, and a squeegee to be moved across the printing screen in order to actuate or operate the squeegee to apply a pressure onto the printing screen and to force the ink through the image apertures defined by the stencil image in the printing screen and onto the garment or other substrate.

For example, U.S. Pat. No. 3,964,385 to Knight discloses one of the typical unitary screen printing devices comprising a pivotal rectangular open centered frame for supporting a printing screen, and a squeegee is required to be moved across the printing screen in order to apply a pressure onto the printing screen and to force the ink through the printing screen and onto the garment or other substrate.

However, normally the squeegee is actuated or operated manually and may not be easily operated or controlled.

U.S. Pat. No. 5,355,791 to Benedetto et al. discloses another typical all in one screen printing machine comprising a working surface that supports the image to be printed and a print screen, and a squeegee is also required to be moved across the print screen in order to apply a pressure onto the print screen and to force the ink through the print screen and onto the garment or other substrate.

However, similarly the squeegee is actuated or operated manually and may not be easily operated or controlled.

U.S. Pat. No. 5,402,719 to Starkweather, Sr. discloses a further typical silk screen working station comprising a work plate for supporting a printing screen, and a squeegee is also required to be moved across the printing screen in order to apply a pressure onto the printing screen and to force the ink through the printing screen and onto the garment or other substrate.

However, similarly the squeegee is actuated or operated manually and may not be easily operated or controlled.

The present invention has arisen to mitigate and/or obviate the afore-described disadvantages of the conventional screen printing machines.

### SUMMARY OF THE INVENTION

The primary objective of the present invention is to provide a screen printing machine including a squeegee actuating or operating device for easily actuating or operating a squeegee to apply a pressure onto a printing screen and to force the ink through the printing screen and onto the substrate.

In accordance with one aspect of the invention, there is provided a screen printing machine comprising a platen for supporting a substrate to be printed, a printing screen disposed above the platen and the substrate, a squeegee to be moved across the printing screen in order to apply a pressure onto the printing screen and to force an ink through the printing screen and onto the substrate, a conveyer device disposed below the platen, and a squeegee actuating device supported on the conveyer device for being moved relative to the platen and the printing screen by the conveyer device, the squeegee actuating device including a housing having a chamber formed therein, and at least one electromagnetic device received in the chamber of the housing, the electromagnetic device including a coil having a compartment formed therein, a core received in the compartment of the core, and a first magnet disposed above the core and secured to the core and the housing for being actuated by the core to selectively attract the squeegee to press onto the printing screen and to force the ink through the printing screen and onto the substrate, and to selectively release the squeegee from the printing screen.

The core and the first magnet are preferably secured to the housing with a fastener. The electromagnetic device includes at least one second magnet disposed above the coil and attracted to the first magnet, and the second magnet is preferably disposed beside the first magnet.

The first magnet preferably includes at least one inclined surface formed therein for allowing the magnetic force of the magnet to be suitably concentrated. The first magnet is preferably a permeable magnet.

A protective insert may further be provided and engaged into the housing for sealing the housing and for protecting the core and the first magnet, or a protective cover may further be provided and engaged onto the housing for covering the housing and for protecting the core and the first magnet.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view illustrating the operation of a screen printing machine in accordance with the present invention;

FIG. 2 is a perspective view of a squeegee actuating or operating device for the screen printing machine;

FIG. 3 is a partial exploded view of squeegee actuating or operating device for the screen printing machine;

FIG. 4 is a cross sectional view of the squeegee actuating or operating device for the screen printing machine taken along lines 4-4 of FIG. 2;

FIG. 5 is an enlarged partial perspective view of the squeegee actuating or operating device for the screen printing machine;

FIGS. 6, 7, 8, 9 are cross sectional views similar to FIG. 4, illustrating the operation of the squeegee actuating or operating device for the screen printing machine;

FIG. 10 is another perspective view similar to FIG. 2 illustrating the other arrangement of the squeegee actuating or operating device for the screen printing machine; and

FIG. 11 is a further perspective view similar to FIGS. 2 and 10 illustrating the further arrangement of the squeegee actuating or operating device for the screen printing machine.

### DETAILED DESCRIPTION OF THE PREFERRED EMBODIMENT

Referring to the drawings, and initially to FIG. 1, a screen printing machine 1 in accordance with the present invention comprises a platen 10 for supporting a garment or other substrate 8 to be printed, a printing screen 80 disposed or supported above the platen 10 and the garment or other substrate 8, and a squeegee 20 to be moved across the printing screen 80 in order to actuate or operate the squeegee 20 to apply a pressure onto the printing screen 80 and to force the ink 81 through the image apertures defined by the stencil image (not shown) in the printing screen 80 and onto the garment or other substrate 8, and a conveyer belt or device 88 disposed or supported below the platen 10 for supporting or carrying a squeegee actuating or operating device 3.

The squeegee actuating or operating device 3 is to be moved along or relative to the platen 10 by the conveyer device 88 in order to actuate or operate the squeegee 20 to apply a pressure onto the printing screen 80 and to force the ink 81 through the image apertures defined by the stencil image in the printing screen 80 and then to force the ink 81 onto the garment or other substrate 8. The above-described structure including the squeegee 20, the platen 10 and the garment or other substrate 8, and the printing screen 80 and the ink 81, and the conveyer device 88 is not related to the present invention and will not be described in further details.

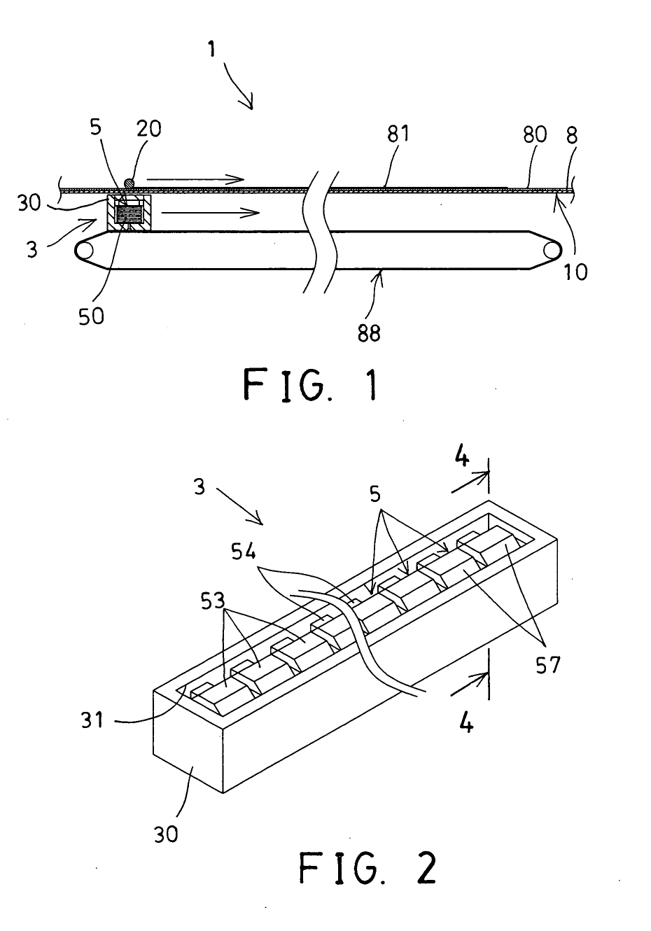

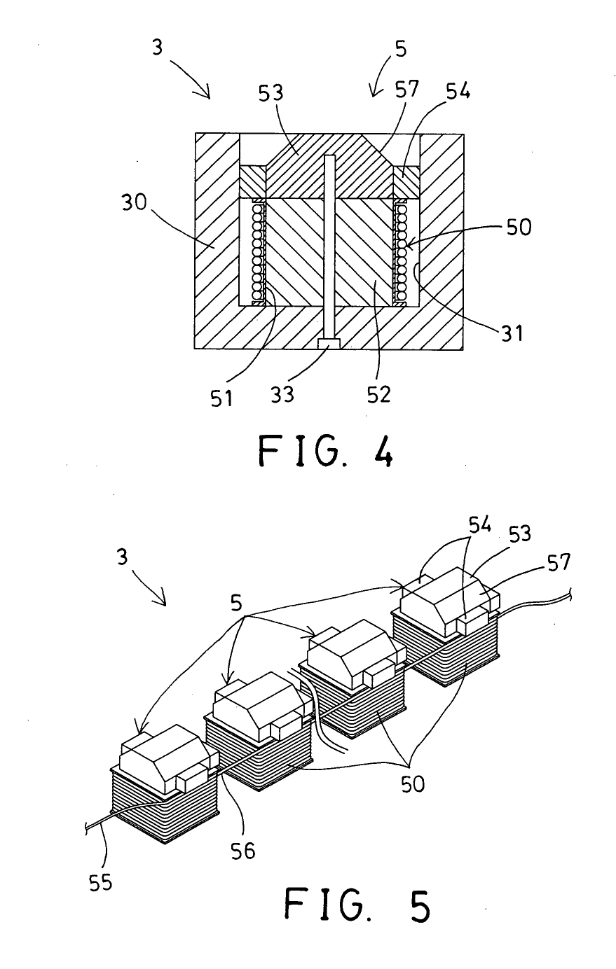

As shown in FIGS. 2-5, the squeegee actuating or operating device 3 includes an outer receptacle or housing 30 having a chamber 31 formed therein for receiving one or more electromagnetic devices 5, in which each electromagnetic device 5 include a coil 50 having a compartment 51 formed therein for receiving a magnet or core 52 therein, another magnet 53, such as a permeable magnet 53 disposed or supported above the core 52 and secured to the core 52 and the housing 30 with a fastener 33, or the fastener 33 may solidly secure the core 52 and the magnet 53 to the housing 30 for allowing the core 52 and the magnet 53 to be solidly secured together to form a magnet unit, best shown in FIGS. 4 and 6-9.

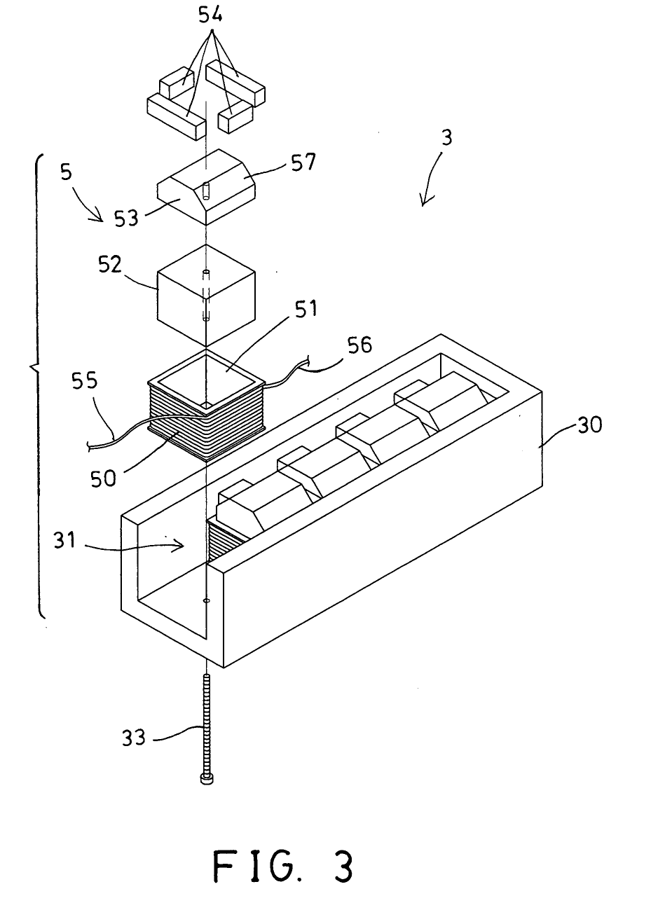

The electromagnetic devices 5 each may further include one or more (such as four) further magnets 54 disposed or engaged onto the coil 50 and engaged with or attracted to the peripheral portion or the side portions of the magnet 53 for allowing the magnets 53, 54 to have the same or the identical polarity. As shown in FIGS. 3 and 5, the coils 50 of the electromagnetic devices 5 each include two ends 55, 56, and the ends 55, 56 of the coils 50 are coupled in series for coupling the coils 50 together in series. It is preferable that the magnets 53 each include one or more (such as two) cut off portions or notches or inclined surfaces 57 formed therein for allowing the magnetic force of the magnets 53 to be suitably concentrated.

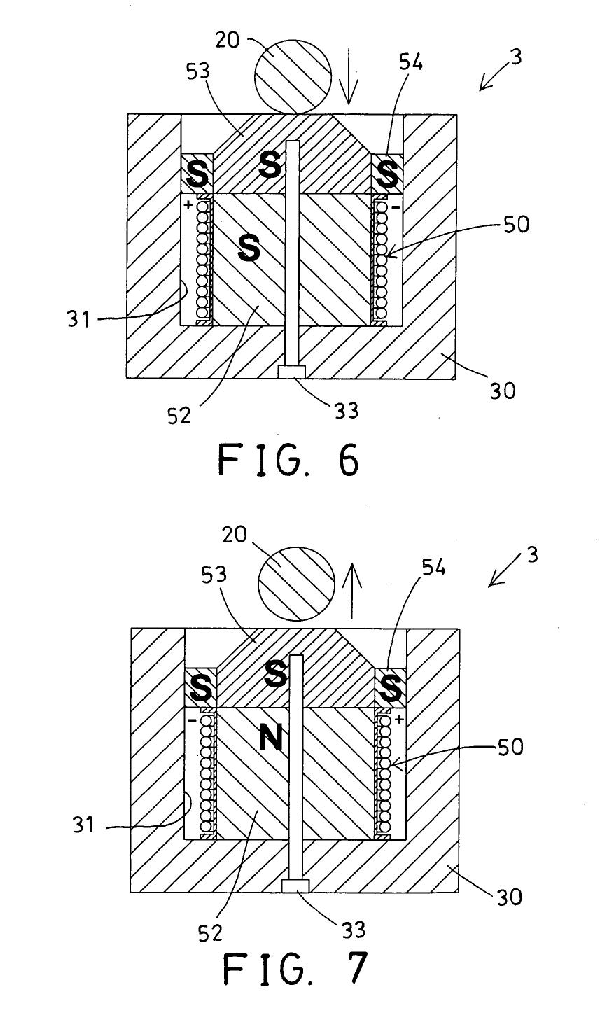

In operation, as shown in FIG. 6, when the coils 50 are energized or applied with the positive direction voltage, and the electric energy applied to the coils 50 is then cut off or turned off right away, the core 52 may be formed into the same or the identical polarity “S” as that of the magnets 53, 54, and at this moment, the core 52 and the magnets 53, 54 are formed into a unitary magnet 52-54 and may apply a strong attract force to attract the squeegee 20 to press onto the printing screen 80 and to force the ink 81 through the printing screen 80 and onto the garment or other substrate 8 (FIG. 1).

After the printing process, the coils 50 are energized or applied with the negative direction voltage, and the electric energy applied to the coils 50 is then cut off or turned off right away, the core 52 may be formed into the polarity “N” (FIG. 7) different from that of the magnets 53, 54, and at this moment, the magnetic forces of the core 52 and the magnets 53, 54 will be offset, and the squeegee 20 may be released. It is to be noted that the coils 50 are required to be energized for only a short period of time, such as few seconds, and the electric energy applied to the coils 50 will then be cut off or turned off right away such that the electric energy applied to the coils 50 is greatly reduced or saved, and such that the coils 50 are not required to be worked for a long period of time, and such that the temperature of the coils 50 will not be increased.

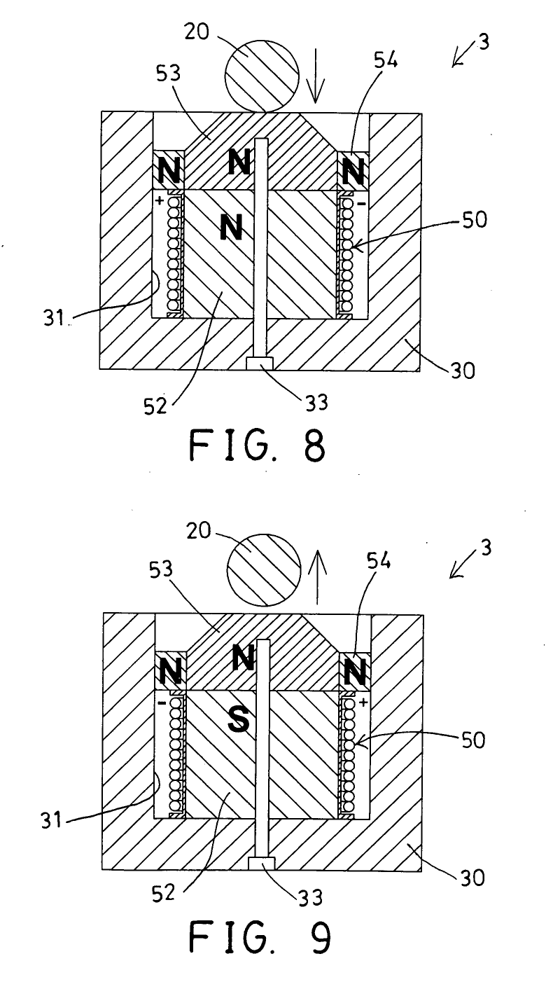

Alternatively, as shown in FIG. 8, the polarity “N” of the magnets 53, 54 may be selected as “N” and different from that of the magnets 53, 54 as shown in FIGS. 6 and 7, the coils 50 may also be energized and the electric energy applied to the coils 50 may then be cut off or turned off right away, and the core 52 may also be formed into the same or the identical polarity “N” as that of the magnets 53, 54, and at this moment, the core 52 and the magnets 53, 54 are formed into a unitary magnet 52-54 and may apply a strong attract force to attract the squeegee 20 to press onto the printing screen 80 and to force the ink 81 through the printing screen 80 and onto the garment or other substrate 8.

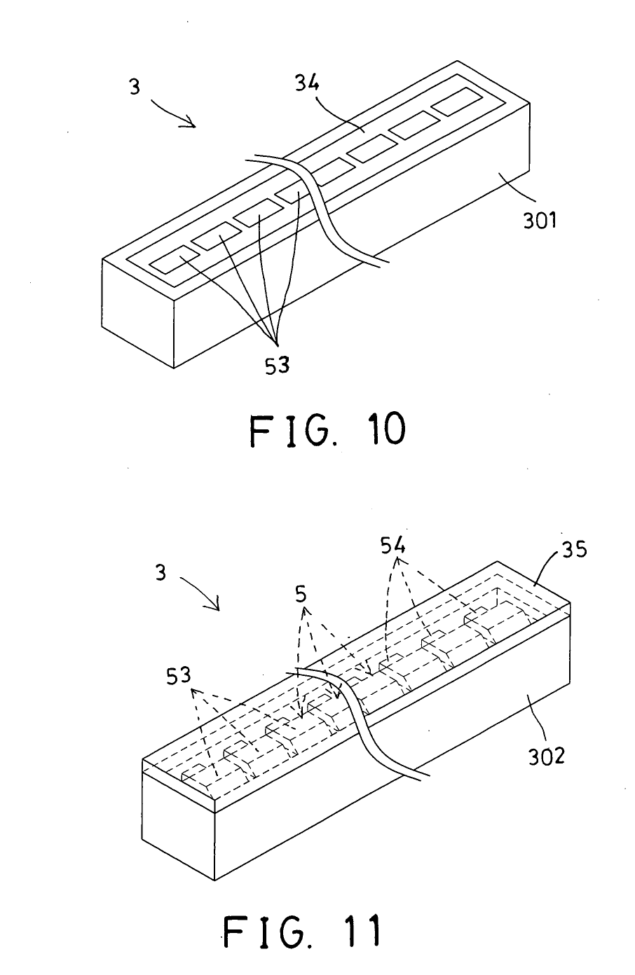

After the printing process, the coils 50 are then energized with the reverse voltage, and the electric energy applied to the coils 50 is then cut off or turned off right away, the core 52 may be formed into the polarity “S” (FIG. 9) different from that of the magnets 53, 54, and at this moment, the magnetic forces of the core 52 and the magnets 53, 54 will be offset, and the squeegee 20 may be released. As shown in FIG. 10, a protective insert or layer 34 may further be provided and engaged into the housing 301 for suitably sealing the housing 301 and for protecting the magnets 53, 54 of the electromagnetic devices 5. Or a protective cover 35 (FIG. 11) may further be provided and engaged onto the housing 301 for suitably covering the housing 302 and for protecting the magnets 53, 54 of the electromagnetic devices 5.

Accordingly, the screen printing machine in accordance with the present invention includes a squeegee actuating or operating device for easily actuating or operating a squeegee to apply a pressure onto a printing screen and to force the ink through the printing screen and onto the substrate.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A screen printing machine comprising:
a platen for supporting a substrate to be printed,
a printing screen disposed above said platen and the substrate,
a squeegee to be moved across said printing screen in order to apply a pressure onto said printing screen and to force an ink through said printing screen and onto the substrate,
a conveyer device disposed below said platen, and
a squeegee actuating device supported on said conveyer device for being moved relative to said platen and said printing screen by said conveyer device, said squeegee actuating device including a housing having a chamber formed therein, and at least one electromagnetic device received in said chamber of said housing, said at least one electromagnetic device including a coil having a compartment formed therein, a core received in said compartment of said core, and a first magnet disposed above said core and secured to said core and said housing for being actuated by said core to selectively attract said squeegee to press onto said printing screen and to selectively release said squeegee.

2. The screen printing machine as claimed in claim 1, wherein said core and said first magnet are secured to said housing with a fastener.

3. The screen printing machine as claimed in claim 1, wherein said at least one electromagnetic device includes at least one second magnet disposed above said coil and attracted to said first magnet.

4. The screen printing machine as claimed in claim 3, wherein said at least one second magnet is disposed beside said first magnet.

5. The screen printing machine as claimed in claim 1, wherein said first magnet includes at least one inclined surface formed therein.

6. The screen printing machine as claimed in claim 1, wherein said first magnet is a permeable magnet.

7. The screen printing machine as claimed in claim 1 further comprising a protective insert engaged into said housing for sealing said housing and for protecting said core and said first magnet.

8. The screen printing machine as claimed in claim 1 further comprising a protective cover engaged onto said housing for covering said housing and for protecting said core and said first magnet.
